(19) United States
(12) Patent Application Publication
(10) Pub. No.: US 2022/0004668 A1
(43) Pub. Date: Jan. 6, 2022

(54) LOCKABLE PARTITION IN NVME DRIVES WITH DRIVE MIGRATION SUPPORT

(71) Applicant: Intel Corporation, Santa Clara, CA (US)

(72) Inventors: Prashant Dewan, Portland, OR (US); Thomas Bowen, Albuquerque, NM (US); Anoop Mukker, Folsom, CA (US)

(73) Assignee: Intel Corporation, Santa Clara, CA (US)

(21) Appl. No.: 17/477,202

(22) Filed: Sep. 16, 2021

(51) Int. Cl. G06F 21/78; G06F 3/06; H04L 9/32

(52) U.S. Cl. CPC G06F 21/78; G06F 3/0622; H04L 9/3242; G06F 3/0679; G06F 3/0644

(57) ABSTRACT

Methods and apparatus relating to a lockable partition in NVMe (Non-Volatile Memory express) drives with drive migration support are described. In an embodiment, a Non-Volatile Memory (NVM) device stores data and partition logic circuitry locks or unlocks a partition on the NVM device in response to a command. The NVM device is physically migratable to a different platform and the NVM device is protected after power loss during runtime. The partition logic circuitry locks or unlocks the partition in response to the command and a cryptographic key. Other embodiments are also disclosed and claimed.

### FIELD

The present disclosure generally relates to the field of electronics. More particularly, an embodiment relates to techniques for provision of a lockable partition in NVMe (Non-Volatile Memory express) drives with drive migration support.

### BACKGROUND

Client and server platforms may utilize a special partition in their storage drives to enhance security. To enhance performance, these storage drives can include Non-Volatile Memory express (NVMe) drives.

For example, while Universal Flash Storage (UFS) specification for flash storage drives (e.g., used for digital cameras, mobile phones and consumer electronic devices) may be capable of utilizing lock bits to enhance security, these bits are reset on a cold boot, so there is no protection after power loss. Also, while some NVMe drives may support Replay Protected Memory Block (RPMB) partitions, these partitions are not designed to be migratable between platforms.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system with an inline memory expansion engine, according to an embodiment.

FIG. 2 illustrates a block diagram of two-level system main memory, according to an embodiment.

FIG. 3 illustrates a flow diagram of a method to handle a new command directed to a lockable partition, according to an embodiment.

FIG. 4 illustrates a flow diagram of a method to handle a new command directed to a lockable partition after select operations of FIG. 3, according to an embodiment.

FIG. 5 illustrates a flow diagram of a method to handle a new command directed to a lockable partition after select operations of FIGS. 3 and 4, according to an embodiment.

FIG. 6A is a block diagram illustrating both an exemplary in-order pipeline and an exemplary register renaming, out-of-order issue/execution pipeline according to embodiments.

FIG. 6B is a block diagram illustrating both an exemplary embodiment of an in-order architecture core and an exemplary register renaming, out-of-order issue/execution architecture core to be included in a processor according to embodiments.

FIG. 7 illustrates a block diagram of an SOC (System On Chip) package in accordance with an embodiment.

FIG. 8 is a block diagram of a processing system, according to an embodiment.

FIG. 9 is a block diagram of an embodiment of a processor having one or more processor cores, according to some embodiments.

FIG. 10 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, some client and server platforms may utilize a special partition in their storage drives to enhance security. However, the current solutions such as UFS lock bits (e.g., by design) and RPMB partitions cannot survive a power loss or migration amongst platforms, respectively.

To this end, some embodiments provide a lockable partition in storage (e.g., NVMe) drives with drive migration support. In an embodiment, the lockable partition is implemented as an RPMB partition. In one or more embodiments, computing systems (e.g., client and server platforms) utilize a special partition in the storage drives with one or more of the following properties: (1) integrity protected—untrusted software is unable (or otherwise blocked/disallowed) from modifying the special partition; (2) migratable—one drive from one platform is physically migratable to another platform if needed; (3) protection even when a storage device loses power—modern standby in client platforms removes power from one or more drives while the Operating System (OS) is running (and, as a result, the protection needs to persistent even when a drive is shut down and/or powered back up during OS runtime); and/or (4) authorized software is able to modify the partition. As discussed herein, “modern standby” generally refers to power state of the system/platform where the user gets an instant on experience since the CPU is not switched off but transitioned into an extremely low power consumption state. However, most of the peripherals like storage drives are recommended to be switched off.

By contrast, there are currently no solutions that meet (e.g., all) the four requirements mentioned above. As previously mentioned, some examples of current solutions: UFS drives have lock bits but they are reset on a cold boot, violating (3) and current NVMe drives that support RPMB partitions are designed to be non-migratable, violating (2).

Hence, at least one embodiment provides migration of storage devices (2) even during (e.g., modern) standby operations (3). Further, one or more embodiments provide migration with standby, as well as integrity (1) and/or modification by authorized software (4).

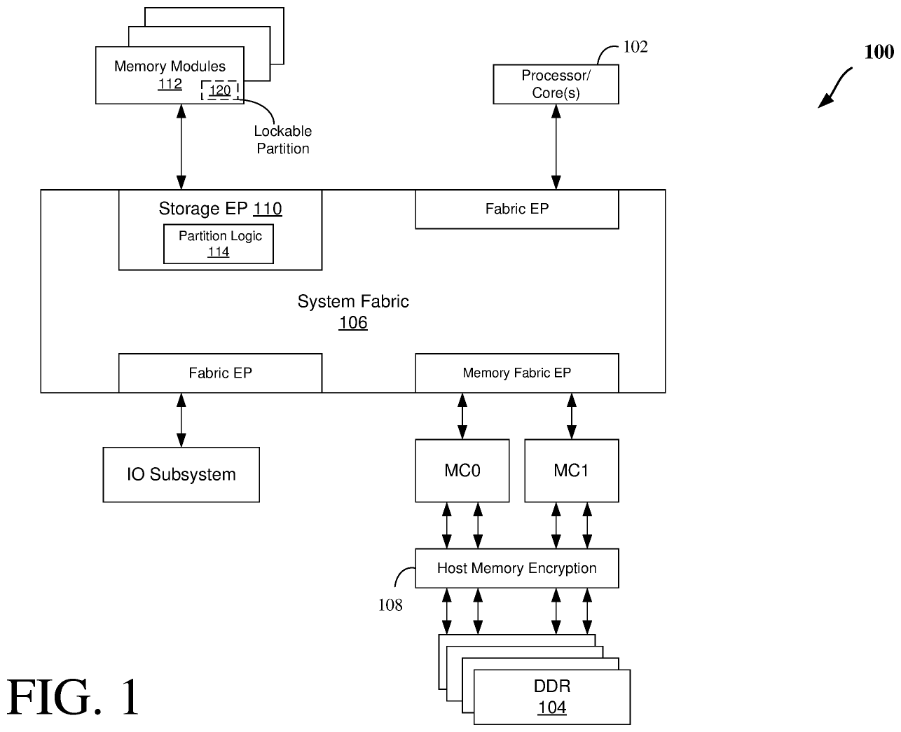

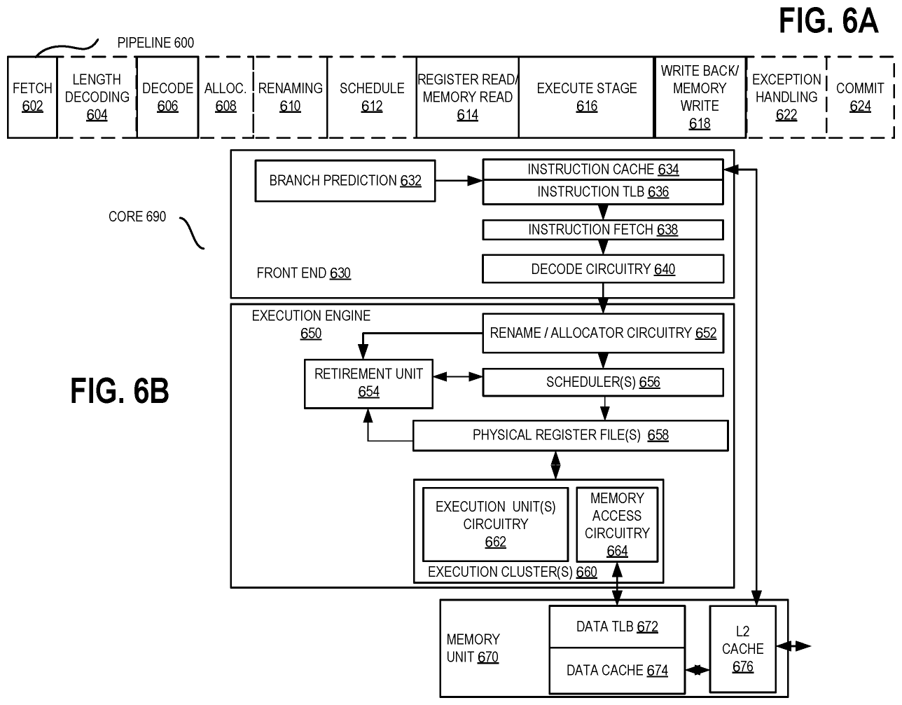

FIG. 1 illustrates a block diagram of a system 100 with a lockable partition in storage (e.g., NVMe) drives and drive migration support, according to an embodiment. The system 100 includes one or more processor/cores 102 that communicate with main memory 104 (such as one or more Double Data Rate (DDR) Dynamic Random Access Memory (DRAM) modules) via a system fabric 106. The system 100 and/or processor(s)/core(s) 102 may be the same or similar to those discussed with reference to FIGS. 6, 7, 8, 9, and/or 10.

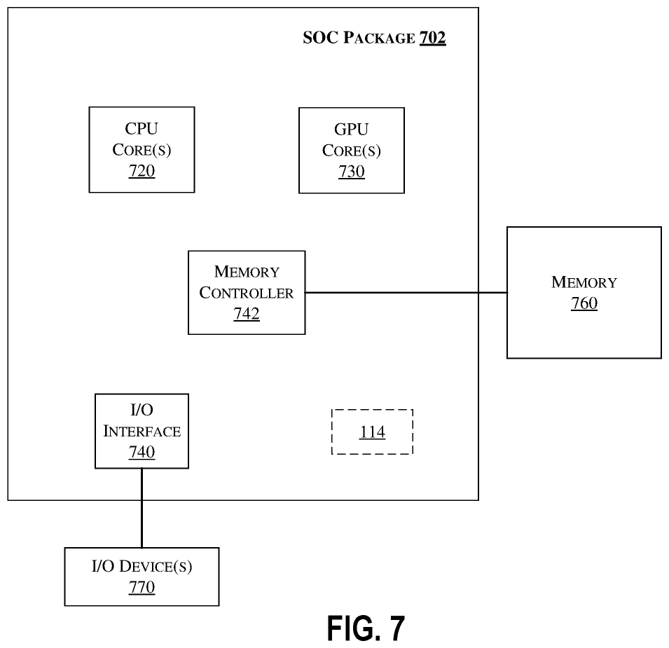

As shown, the system fabric 106 includes a memory fabric EP (or endpoint) that communicates with memory 104 via one or more memory controllers (MCO and MCI). A host memory encryption engine 108 encrypts/decrypts data stored/read from the memory 104 in one embodiment. The system fabric 106 also includes other endpoints to provide a communication channel with other components of system 100, such as IO (Input/Output) subsystem, as well as a storage EP 110 (e.g., to couple non-volatile memory to system 100 such as a disk drive, NVMe device, Solid State Drive (SSD), etc.). One or more memory modules (such as NVMe and/or SSD drives) 112 attached to the storage EP 110 may be protected cryptographically by a partition logic 114, in an embodiment. In one embodiment, at least parts of the system 100 (such as processor 102, DDR 104, system fabric 106, logic 108, EP 110, and/or logic 114) may be implemented as a System On Chip (SOC or SoC) such as discussed with reference, see, e.g., FIG. 7. In one or more embodiments, the partition logic 114 may be provided on a processor/core.

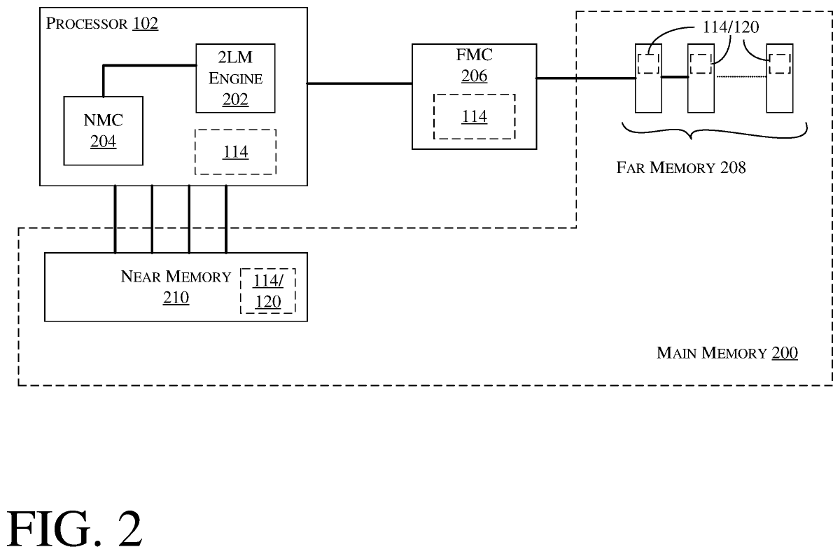

Moreover, a storage controller such as an SPI (Serial Peripheral Interface) controller or a UFS (Universal Flash Storage) controller may be used to access memory modules 112 and/or a lockable partition 120 (which may be provided on one or more of the memory modules 112 by utilizing the partition logic 114 as will be further discussed herein). Also, in at least one embodiment, the memory modules 112 and/or DDR 104 can be used as 1LM (1 Level Memory) or 2LM (2 Level Memory) host attached memory, as will be further discussed with reference to FIG. 2.

FIG. 2 illustrates a block diagram of two-level system main memory, according to an embodiment. Some embodiments are directed towards system main memory 200 comprising two levels of memory (alternatively referred to herein as “2LM”) that include cached subsets of system disk level storage (in addition to, for example, run-time data). This main memory includes a first level memory 210 (alternatively referred to herein as “near memory”) comprising smaller and/or faster memory made of, for example, volatile memory (e.g., including DRAM (Dynamic Random Access Memory) such as 104), NVM (Non-Volatile Memory), etc.; and a second level memory 208 (alternatively referred to herein as “far memory”) which comprises larger and/or relatively slower (with respect to the near memory) volatile memory (e.g., memory 104) or nonvolatile memory storage (e.g., NVM).

In an embodiment, the far memory is presented as “main memory” to the host Operating System (OS), while the near memory is a cache for the far memory that is transparent to the OS, thus rendering the embodiments described below to appear the same as general main memory solutions. The management of the two-level memory may be done by a combination of logic and modules executed via the host central processing unit (CPU) 102 (which is interchangeably referred to herein as “processor”). Near memory may be coupled to the host system CPU via one or more high bandwidth, low latency links, buses, or interconnects for efficient processing such as the system fabric 106. Far memory may be coupled to the CPU via one or more low bandwidth, high latency links, buses, or interconnects (as compared to that of the near memory), e.g., that may operate in accordance with Compute eXpress Link™(CXL™) or other (e.g., cache coherent) interconnects in various embodiments.

Referring to FIG. 2, main memory 200 provides run-time data storage and access to the contents of system disk storage memory (such as a disk drive or NVMe device) to CPU 102. The CPU may include cache memory, which would store a subset of the contents of main memory 200. Far memory may comprise either volatile or nonvolatile memory as discussed herein. In such embodiments, near memory 210 serves a low-latency and high-bandwidth (i.e., for CPU 102 access) cache of far memory 208, which may have considerably lower bandwidth and higher latency (i.e., for CPU 102 access).

In an embodiment, near memory 210 is managed by Near Memory Controller (NMC) 204, while far memory 208 is managed by Far Memory Controller (FMC) 206. FMC 206 reports far memory 208 to the system operating system (OS) as main memory (i.e., the system OS recognizes the size of far memory 208 as the size of system main memory 200). The system OS and system applications are “unaware” of the existence of near memory 210 as it is a “transparent” cache of far memory 208. CPU 102 further comprises 2LM engine module/logic 202. The “2LM engine” is a logical construct that may comprise hardware and/or micro-code extensions to support two-level main memory 200. For example, 2LM engine 202 may maintain a full tag table that tracks the status of all architecturally visible elements of far memory 208. For example, when CPU 102 attempts to access a specific data segment in main memory 200, 2LM engine 202 determines whether the data segment is included in near memory 210; if it is not, 2LM engine 202 fetches the data segment in far memory 208 and subsequently writes the data segment to near memory 210 (similar to a cache miss). It is to be understood that, because near memory 210 acts as a “cache” of far memory 208, 2LM engine 202 may further execute data perfecting or similar cache efficiency processes.

Further, 2LM engine 202 may manage other aspects of far memory 208. For example, in embodiments where far memory 208 comprises nonvolatile memory (e.g., NVM), it is understood that nonvolatile memory such as flash is subject to degradation of memory segments due to significant reads/writes. Thus, 2LM engine 202 may execute functions including wear-leveling, bad-block avoidance, and the like in a manner transparent to system software. For example, executing wear-leveling logic may include selecting segments from a free pool of clean unmapped segments in far memory 208 that have a relatively low erase cycle count.

In some embodiments, near memory 210 may be smaller in size than far memory 208, although the exact ratio may vary based on, for example, intended system use. In such embodiments, it is to be understood that because far memory 208 may comprise denser and/or cheaper nonvolatile memory, the size of the main memory 200 may be increased cheaply and efficiently and independent of the amount of DRAM (i.e., near memory 210) in the system.

In one embodiment, far memory 208 stores data in compressed form and near memory 210 includes the corresponding uncompressed version. Thus, when near memory 210 request content of far memory 208 (which could be a non-volatile DIMM in an embodiment), FMC 206 retrieves the content and returns it in fixed payload sizes tailored to match the compression algorithm in use (e.g., a 256B transfer).

As shown in FIG. 2, the partition logic 114 and/or the lockable partition 120 may be provided in one or more locations in FIG. 2, depending on the implementation.

Furthermore, an embodiment provides a device partition that supports integrity using a device key. The device key is shared between the device and the platform. The device key may be programmed into the device and thereafter if a blob is written to the device, it has to have a header that contains H=HMAC (Key, blob), where “HMAC” (referred to as keyed-hash message authentication code or hash-based message authentication code) is a specific type of Message Authentication Code (MAC) involving a cryptographic hash function and a secret cryptographic key. As discussed herein, a “blob” generally refers to data or a binary object.

In one embodiment, the platform and the device are expected to protect the device key. Before drive migration, the platform can reset the key in the drive by writing a reset command R, R=HMAC (Key, “Reset”, OPTIONS). This ensures only the software that has the device key can perform the reset. While some embodiments are discussed herein with reference to a “command”, embodiments are not limited to this and any mechanism may be used to cause a device (such as an NVMe drive or other storage device) to perform one or more of the operations discussed with reference to the command, including for example causing the device to perform an operation by writing to a register or a physical interface, etc.

In an embodiment, on reset all, the contents of the (lockable) partition are wiped, thereby ensuring no unencrypted confidential information is accidentally transferred to the new platform. Once reset, the drive can be reprogrammed using a new device key. However, embodiments are not limited to this approach and drive migration may be implemented as a simple plug and play implementation, e.g., where the boot partition is maintained so that the new platform can accept the drive and use it directly without needing to recover anything on the boot partition. On the other hand, transitioning from one system to a different system with a completely different OEM (Original Equipment Manufacturer) or even model may require clearing and resetting the boot partition anyways. Hence, wiping of the partition can be made optional and the key owner may decide if the partition is to also be deleted when the key is deleted.

Alternatively, the device key could be used to unlock the partition by submitting a command, H=HMAC (Key, “Unlock”) and lock it at a later time. The platform and the device are expected to protect the device key. However, embodiments are not limited to this approach and every blob may not be signed with a device key, e.g., for faster write operations. In this case, the device key may be used to unlock the partition (instead of the blob). Alternatively, every blob has to be unlocked to ensure that only a key holder is permitted to read or write to the partition. Unlocking just the partition may be used when there is a single agent running on the platform but not when there are multiple agents running on the platform. Moreover, in some embodiments, the device key can be reset by using the key itself and/or a Physical Security Identifier (PSID). The lockable partition may be provided on a Trusted Computing Group (TCG) drive in some embodiments. A TCG derive may also support PSID.

In at least one embodiment, there might be some platforms where the migration is not needed and the drive does not need to be reset. For those platforms, the platform can configure the drive to NO_RESET_ALLOWED, and once configured, the drive key can never be reset for the life of the drive (e.g., by using a fuse). Also, there might be some platforms where deletion of partition information is not desired. In this case, the platform can be configured with NO_PARTITON_DELETION in the Options field of the reset command.

Moreover, in some situations, the source platform may be broken/inoperational and the drive key in the platform is no longer retrievable. For these scenarios, each drive may receive a PSID_RESET_KEY command whose hash, HASH_PSID_RESET_KEY=KDF (PSID_RESET_KEY) may be saved in the drive itself, where “KDF” or Key Derivation Function is a cryptographic function (such as a hash) that derives one or more secret keys from a secret value. This reset key can be used to reset the drive partition key but only with physical access of the drive. For example, the reset key can be physically printed or barcoded onto the drive such that only physical access of the drive will allow someone to access the reset key. In one embodiment, the reset behavior with the reset key includes deleting all the contents of the partition and deleting the device key from the drive.

Also, while a hash function may be used, embodiments are not limited to a hash function and the reset key validation may utilize another verification mechanism instead of a hash function. For instance, the reset key may be programmed at device manufacturing time and is not readable over an interface but can then be used by the device to verify that the host has provided the same reset key that was programmed at manufacturing time (which may also be printed on the device label).

In an embodiment, the platform may disable the RESET_KEY. The drive could also support the configuration to disable the RESET_KEY, DISABLE_RESET_KEY, when configuring the key. Additionally, since some embodiments use a key for lock/unlock vs. a bit, the locking effect can persist even when the device is completely shut down, e.g., meeting requirements for protection during the reset of the device.

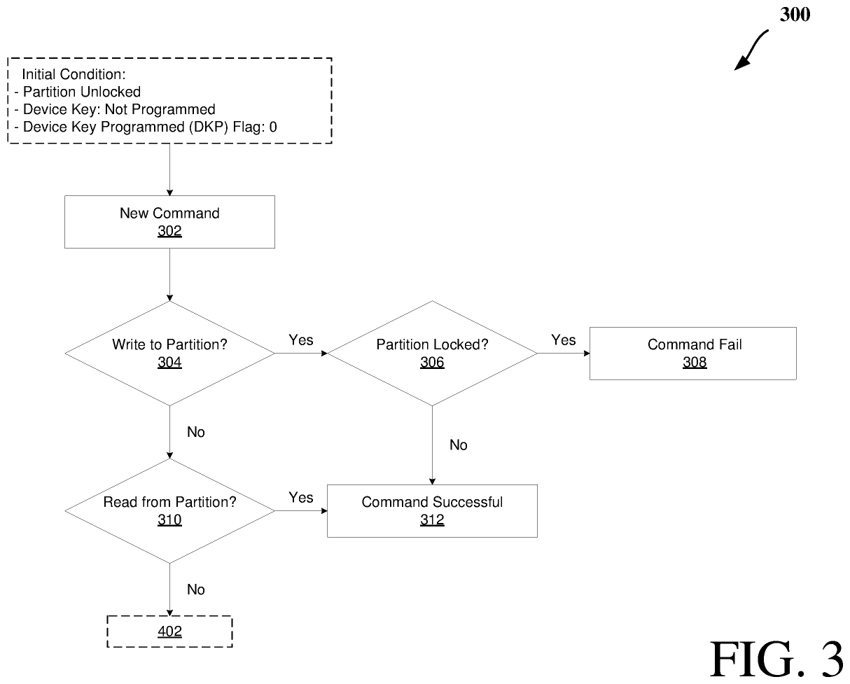

FIG. 3 illustrates a flow diagram of a method 300 to handle a new command directed to a lockable partition, according to an embodiment. One or more components discussed with reference to FIGS. 1-2 (such as partition logic 114) may be used to perform one or more of the operations of method 300. As noted on FIG. 3, the initial condition includes an unlocked partition, an unprogrammed device key, and a Device Key Programmed (DKP) flag of 0 (indicating that the device key is not programmed).

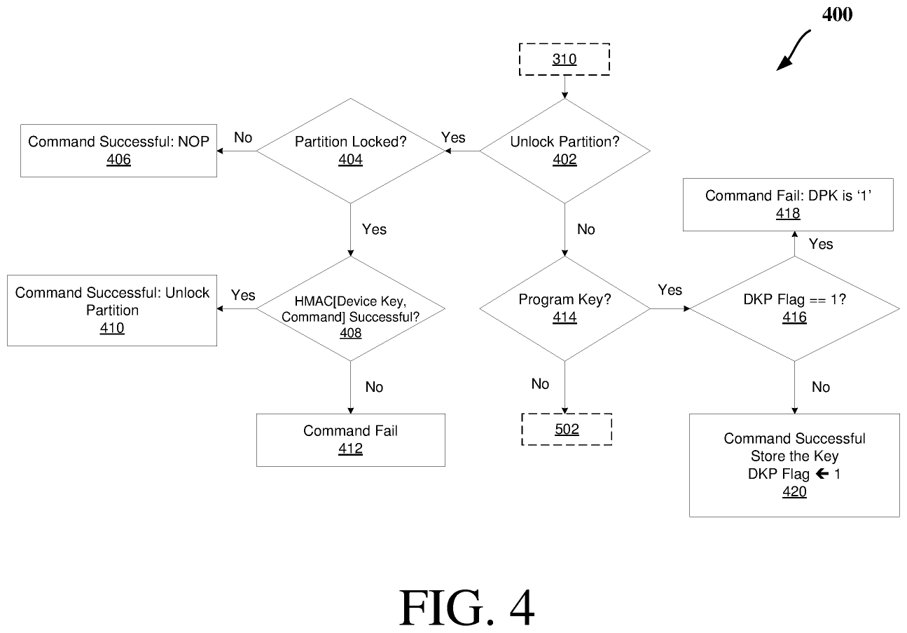

Referring to FIGS. 1-3, at operation 302 a new command directed that lockable partition is received. Operation 304 determines whether the new command is trying to write to the partition and operation 306 determines whether the partition is locked. If the partition is locked at 306, operation 308 indicates command failure. If no write is detected at 304, operation 310 determines whether the new command is trying to read from the partition and if so, operation 312 allows the read operation. Also, if the partition is determined not to be locked at 306, method 300 terminates at operation 312. If operation 310 does not detect a read operation, method 300 resumes at operation 402 of FIG. 4.

FIG. 4 illustrates a flow diagram of a method 400 to handle a new command directed to a lockable partition after select operations of FIG. 3, according to an embodiment. One or more components discussed with reference to FIGS. 1-2 (such as partition logic 114) may be used to perform one or more of the operations of method 400.

Referring to FIGS. 1-4, operation 402 determines whether the new command of operation 302 is requesting an unlocking of the partition and if so operation 404 determines whether the partition is locked. If the partition is determined to be unlocked at 404, method 400 terminates at operation 406 with a successful command handling and no further operation (NOP). If the partition is determined to be locked at 404, operation 408 determines whether a hash of the device key and command (i.e., HMAC[Device Key, Command]) is successful. If so, method 400 terminates at operation 410 with a successful command and unlocking the partition. If the hash function determination at 408 is unsuccessful, method 400 terminates at operation 412, indicating the failure of the command.

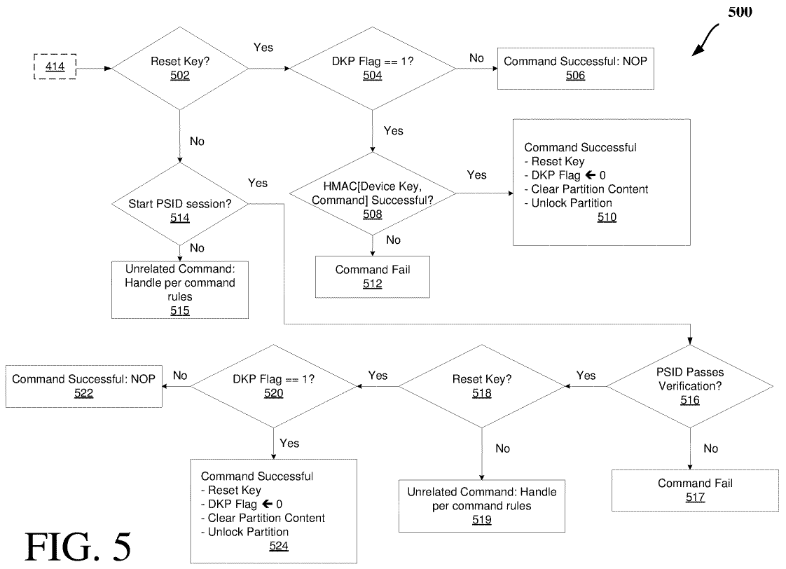

At operation 402, if it is determined that the new command is not requesting to unlock the partition, operation 414 determines whether the command is requesting to program a key, and if so, operation 416 determines whether the DKP flag is 1 (i.e., indicating the device key is programmed). If DKP flag is 1, then method 400 terminates at operation 418 with command failure (since DKP indicates that the device key is already programmed). Otherwise, method 400 terminates at operation 420 with command success, storage of the key, and updating the DKP flag to 1 to indicate the device key is programmed. If, however, operation 414 determines that the command does not aim to program a key, method 400 continues with operation 502 of FIG. 5.

FIG. 5 illustrates a flow diagram of a method 500 to handle a new command directed to a lockable partition after select operations of FIGS. 3 and 4, according to an embodiment. One or more components discussed with reference to FIGS. 1-2 (such as partition logic 114) may be used to perform one or more of the operations of method 500.

Referring to FIGS. 1-5, operation 502 determines whether the new command of operation 302 is directed at resetting the key for the partition. If so, operation 504 determines whether DKP flag is 1 and if not, method 500 terminates at operation 506 with command success and NOP. At operation 504, if the DKP flag is 1, then operation 508 determines whether hash of the device key and command (i.e., HMAC[Device Key, Command]) is successful and if so, operation 510 indicates a successful command, resets the key, sets the DKP flag to 0, clears partition content (optionally as discussed before), and unlocks the partition. If, however, operation 508 determines an unsuccessful has function, method 500 terminates at operation 512 with command failure.

With a negative determination at operation 502, operation 514 determines whether to start a PSID session and if not method 500 terminates at operation 515 indicating an unrelated command (and further handling to be performed in accordance with the specific command rules). However, if it is determined that a PSID session is to be pursued at operation 514, method 500 continues with operation 516 to determine whether the PSID passes verification and if not, the command fails at operation 517.

At operation 516 after verification of the PSID, operation 518 determines whether a reset key is present, and if not, method 500 terminates at operation 519 indicating unrelated command, and further handling to be performed per specific command rules. If the reset key is present at operation 518, operation 520 determines whether the DKP flag is 1 and if not method 500 terminates at operation 522 with command success and NOP. Otherwise, operation 524 indicates a command success, resets the key, sets the DKP flag to 0, clears partition content optionally (as detailed before), and unlocks the partition.

Additionally, some embodiments may be applied in computing systems that include one or more processors (e.g., where the one or more processors may include one or more processor cores), such as those discussed with reference to FIG. 1 et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

FIG. 6A is a block diagram illustrating both an exemplary in-order pipeline and an exemplary register renaming, out-of-order issue/execution pipeline according to embodiments. FIG. 6B is a block diagram illustrating both an exemplary embodiment of an in-order architecture core and an exemplary register renaming, out-of-order issue/execution architecture core to be included in a processor according to embodiments. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a writemask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 7) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 702 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

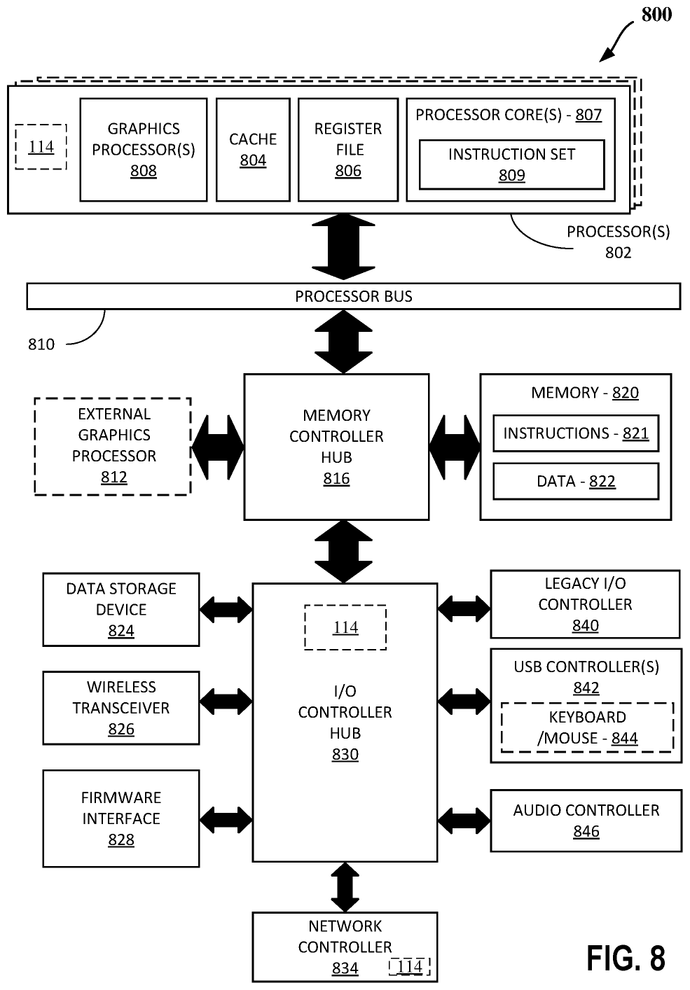

FIG. 8 is a block diagram of a processing system 800, according to an embodiment. In various embodiments the system 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, processor 802 is coupled to a processor bus 810 to transmit communication signals such as address, data, or control signals between processor 802 and other components in system 800. In one embodiment the system 800 uses an exemplary ‘hub’ system architecture, including a memory controller hub 816 and an Input Output (I/O) controller hub 830. A memory controller hub 816 facilitates communication between a memory device and other components of system 800, while an I/O Controller Hub (ICH) 830 provides connections to I/O devices via a local I/O bus. In one embodiment, the logic of the memory controller hub 816 is integrated within the processor.

Memory device 820 can be a dynamic random access memory (DRAM) device, a static random access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 executes an application or process. Memory controller hub 816 also couples with an optional external graphics processor 812, which may communicate with the one or more graphics processors 808 in processors 802 to perform graphics and media operations.

In some embodiments, ICH 830 enables peripherals to connect to memory device 820 and processor 802 via a high-speed I/O bus. The I/O peripherals include, but are not limited to, an audio controller 846, a firmware interface 828, a wireless transceiver 826 (e.g., Wi-Fi, Bluetooth), a data storage device 824 (e.g., hard disk drive, flash memory, etc.), and a legacy I/O controller 840 for coupling legacy (e.g., Personal System 2 (PS/2)) devices to the system. One or more Universal Serial Bus (USB) controllers 842 connect input devices, such as keyboard and mouse 844 combinations. A network controller 834 may also couple to ICH 830. In some embodiments, a high-performance network controller (not shown) couples to processor bus 810. It will be appreciated that the system 800 shown is exemplary and not limiting, as other types of data processing systems that are differently configured may also be used. For example, the I/O controller hub 830 may be integrated within the one or more processor 802, or the memory controller hub 816 and I/O controller hub 830 may be integrated into a discreet external graphics processor, such as the external graphics processor 812.

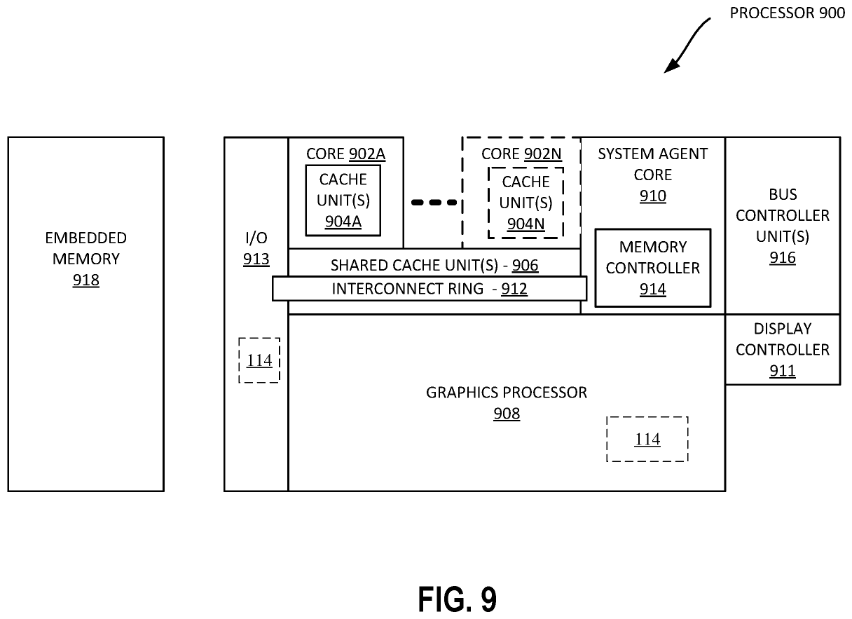

FIG. 9 is a block diagram of an embodiment of a processor 900 having one or more processor cores 902A to 902N, an integrated memory controller 914, and an integrated graphics processor 908. Those elements of FIG. 9 having the same reference numbers (or names) as the elements of any other figure herein can operate or function in any manner similar to that described elsewhere herein, but are not limited to such. Processor 900 can include additional cores up to and including additional core 902N represented by the dashed lined boxes. Each of processor cores 902A to 902N includes one or more internal cache units 904A to 904N. In some embodiments each processor core also has access to one or more shared cached units 906.

The internal cache units 904A to 904N and shared cache units 906 represent a cache memory hierarchy within the processor 900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 906 and 904A to 904N.

In some embodiments, processor 900 may also include a set of one or more bus controller units 916 and a system agent core 910. The one or more bus controller units 916 manage a set of peripheral buses, such as one or more Peripheral Component Interconnect buses (e.g., PCI, PCI Express). System agent core 910 provides management functionality for the various processor components. In some embodiments, system agent core 910 includes one or more integrated memory controllers 914 to manage access to various external memory devices (not shown).

In some embodiments, one or more of the processor cores 902A to 902N include support for simultaneous multi-threading. In such embodiment, the system agent core 910 includes components for coordinating and operating cores 902A to 902N during multi-threaded processing. System agent core 910 may additionally include a power control unit (PCU), which includes logic and components to regulate the power state of processor cores 902A to 902N and graphics processor 908.

In some embodiments, processor 900 additionally includes graphics processor 908 to execute graphics processing operations. In some embodiments, the graphics processor 908 couples with the set of shared cache units 906, and the system agent core 910, including the one or more integrated memory controllers 914. In some embodiments, a display controller 911 is coupled with the graphics processor 908 to drive graphics processor output to one or more coupled displays. In some embodiments, display controller 911 may be a separate module coupled with the graphics processor via at least one interconnect, or may be integrated within the graphics processor 908 or system agent core 910.

In some embodiments, a ring based interconnect unit 912 is used to couple the internal components of the processor 900. However, an alternative interconnect unit may be used, such as a point-to-point interconnect, a switched interconnect, or other techniques, including techniques well known in the art. In some embodiments, graphics processor 908 couples with the ring interconnect 912 via an I/O link 913.

The exemplary I/O link 913 represents at least one of multiple varieties of I/O interconnects, including an on package I/O interconnect which facilitates communication between various processor components and a high-performance embedded memory module 918, such as an eDRAM (or embedded DRAM) module. In some embodiments, each of the processor cores 902 to 902N and graphics processor 908 use embedded memory modules 918 as a shared Last Level Cache.

In some embodiments, processor cores 902A to 902N are homogenous cores executing the same instruction set architecture. In another embodiment, processor cores 902A to 902N are heterogeneous in terms of instruction set architecture (ISA), where one or more of processor cores 902A to 902N execute a first instruction set, while at least one of the other cores executes a subset of the first instruction set or a different instruction set. In one embodiment processor cores 902A to 902N are heterogeneous in terms of microarchitecture, where one or more cores having a relatively higher power consumption couple with one or more power cores having a lower power consumption. Additionally, processor 900 can be implemented on one or more chips or as an SoC integrated circuit having the illustrated components, in addition to other components.

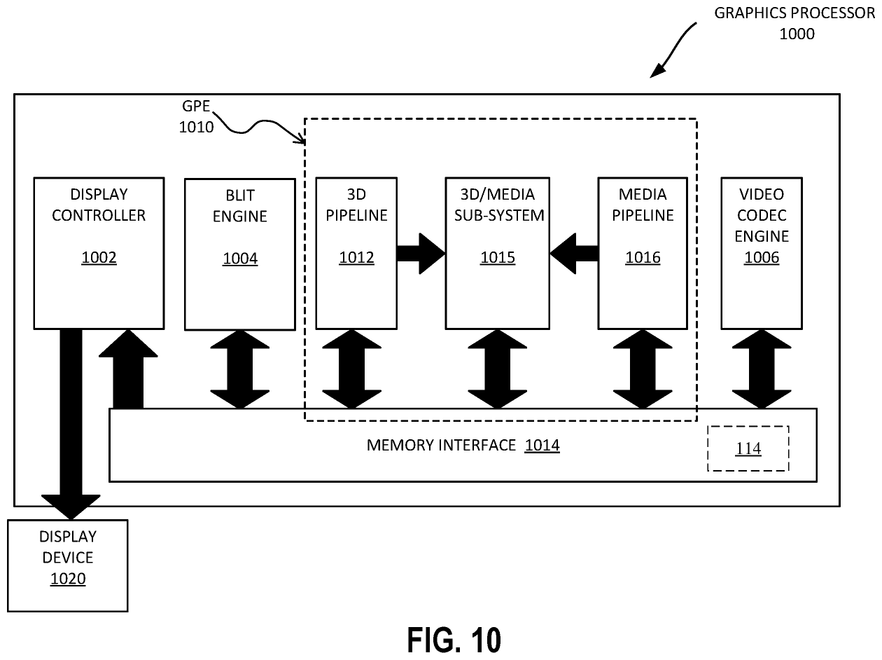

FIG. 10 is a block diagram of a graphics processor 1000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1000 includes a memory interface 1014 to access memory. Memory interface 1014 can be an interface to local memory, one or more internal caches, one or more shared external caches, and/or to system memory.

In some embodiments, graphics processor 1000 also includes a display controller 1002 to drive display output data to a display device 1020. Display controller 1002 includes hardware for one or more overlay planes for the display and composition of multiple layers of video or user interface elements. In some embodiments, graphics processor 1000 includes a video codec engine 1006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1000 includes a block image transfer (BLIT) engine 1004 to perform two-dimensional (2D) rasterizer operations including, for example, bit-boundary block transfers. However, in one embodiment, 3D graphics operations are performed using one or more components of graphics processing engine (GPE) 1010. In some embodiments, graphics processing engine 1010 is a compute engine for performing graphics operations, including three-dimensional (3D) graphics operations and media operations.

In some embodiments, GPE 1010 includes a 3D pipeline 1012 for performing 3D operations, such as rendering three-dimensional images and scenes using processing functions that act upon 3D primitive shapes (e.g., rectangle, triangle, etc.). The 3D pipeline 1012 includes programmable and fixed function elements that perform various tasks within the element and/or spawn execution threads to a 3D/Media sub-system 1015. While 3D pipeline 1012 can be used to perform media operations, an embodiment of GPE 1010 also includes a media pipeline 1016 that is specifically used to perform media operations, such as video post-processing and image enhancement.

In some embodiments, media pipeline 1016 includes fixed function or programmable logic units to perform one or more specialized media operations, such as video decode acceleration, video de-interlacing, and video encode acceleration in place of, or on behalf of video codec engine 1006. In some embodiments, media pipeline 1016 additionally includes a thread spawning unit to spawn threads for execution on 3D/Media sub-system 1015. The spawned threads perform computations for the media operations on one or more graphics execution units included in 3D/Media sub-system 1015.

In some embodiments, 3D/Media subsystem 1015 includes logic for executing threads spawned by 3D pipeline 1012 and media pipeline 1016. In one embodiment, the pipelines send thread execution requests to 3D/Media subsystem 1015, which includes thread dispatch logic for arbitrating and dispatching the various requests to available thread execution resources. The execution resources include an array of graphics execution units to process the 3D and media threads. In some embodiments, 3D/Media subsystem 1015 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a Non-Volatile Memory (NVM) device to store data; and partition logic circuitry to lock or unlock a partition on the NVM device in response to a command, wherein the NVM device is physically migratable to a different platform and the NVM device is to be protected after power loss during runtime, wherein the partition logic circuitry is to lock or unlock the partition in response to the command and a cryptographic key. Example 2 includes the apparatus of example 1, wherein the NVM device is integrity protected. Example 3 includes the apparatus of example 1, wherein authorized software is to be allowed to modify the partition. Example 4 includes the apparatus of example 1, wherein unauthorized software is to be blocked from modifying the partition. Example 5 includes the apparatus of example 1, wherein the cryptographic key is to be programmed into the NVM device. Example 6 includes the apparatus of example 1, wherein each blob to be written to the NVM device is to include a Hash-based Message Authentication Code (HMAC), wherein the HMAC is to be determined based at least in part on the cryptographic key. Example 7 includes the apparatus of example 1, wherein the cryptographic key is to be reset prior to a physical migration of the NVM device to the different platform. Example 8 includes the apparatus of example 1, wherein the cryptographic key is to be reset based in part on a Physical Security Identifier (PSID). Example 9 includes the apparatus of example 1, wherein the cryptographic key is to be reset prior to a physical migration of the NVM device to the different platform in response to a reset request. Example 10 includes the apparatus of example 1, wherein contents of the partition is to be erased in response to a reset request. Example 11 includes the apparatus of example 1, wherein the power loss is in response to a standby invocation. Example 12 includes the apparatus of example 1, wherein the runtime is during operations of an Operating System (OS). Example 13 includes the apparatus of example 1, wherein the NVM device comprises Non-Volatile Memory express (NVMe) storage. Example 14 includes the apparatus of example 1, wherein the NVM device is to operate in accordance with Universal Flash Storage (UFS). Example 15 includes the apparatus of example 1, wherein the partition comprises a Replay Protected Memory Block (RPMB) partition. Example 16 includes the apparatus of example 1, wherein the NVM device comprises a Trusted Computing Group (TCG) device.

Example 17 includes a method comprising: storing data in a Non-Volatile Memory (NVM) device; and locking or unlocking, at partition logic circuitry, a partition on the NVM device in response to a command, wherein the NVM device is physically migratable to a different platform and the NVM device is protected after power loss during runtime, wherein the partition logic circuitry locks or unlocks the partition in response to the command and a cryptographic key. Example 18 includes the method of example 17, further comprising integrity protecting the NVM device. Example 19 includes the method of example 17, further comprising allowing authorized software to modify the partition. Example 20 includes the method of example 17, further comprising blocking unauthorized software from modifying the partition. Example 21 includes the method of example 17, further comprising programming the cryptographic key into the NVM device. Example 22 includes the method of example 17, further comprising causing each blob, to be written to the NVM device, to include a Hash-based Message Authentication Code (HMAC), wherein the HMAC is determined based at least in part on the cryptographic key.

Example 23 includes one or more non-transitory computer-readable media comprising one or more instructions that when executed on a processor configure the processor to perform one or more operations to: store data in a Non-Volatile Memory (NVM) device; and lock or unlock, at partition logic circuitry, a partition on the NVM device in response to a command, wherein the NVM device is physically migratable to a different platform and the NVM device is to be protected after power loss during runtime, wherein the partition logic circuitry is to lock or unlock the partition in response to the command and a cryptographic key. Example 24 includes the one or more computer-readable media of example 23, further comprising one or more instructions that when executed on the at least one processor configure the at least one processor to perform one or more operations to cause integrity protection of the NVM device. Example 25 includes the one or more computer-readable media of example 23, further comprising one or more instructions that when executed on the at least one processor configure the at least one processor to perform one or more operations to cause blocking of unauthorized software from modifying the partition.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry or more generally circuitry or circuit), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a Non-Volatile Memory (NVM) device to store data; and
partition logic circuitry to lock or unlock a partition on the NVM device in response to a command,
wherein the NVM device is physically migratable to a different platform and the NVM device is to be protected after power loss during runtime, wherein the partition logic circuitry is to lock or unlock the partition in response to the command and a cryptographic key.

2. The apparatus of claim 1, wherein the NVM device is integrity protected.

3. The apparatus of claim 1, wherein authorized software is to be allowed to modify the partition.

4. The apparatus of claim 1, wherein unauthorized software is to be blocked from modifying the partition.

5. The apparatus of claim 1, wherein the cryptographic key is to be programmed into the NVM device.

6. The apparatus of claim 1, wherein each blob to be written to the NVM device is to include a Hash-based Message Authentication Code (HMAC), wherein the HMAC is to be determined based at least in part on the cryptographic key.

7. The apparatus of claim 1, wherein the cryptographic key is to be reset prior to a physical migration of the NVM device to the different platform.

8. The apparatus of claim 1, wherein the cryptographic key is to be reset based in part on a Physical Security Identifier (PSID).

9. The apparatus of claim 1, wherein the cryptographic key is to be reset prior to a physical migration of the NVM device to the different platform in response to a reset request.

10. The apparatus of claim 1, wherein contents of the partition is to be erased in response to a reset request.

11. The apparatus of claim 1, wherein the power loss is in response to a standby invocation.

12. The apparatus of claim 1, wherein the runtime is during operations of an Operating System (OS).

13. The apparatus of claim 1, wherein the NVM device comprises Non-Volatile Memory express (NVMe) storage.

14. The apparatus of claim 1, wherein the NVM device is to operate in accordance with Universal Flash Storage (UFS).

15. The apparatus of claim 1, wherein the partition comprises a Replay Protected Memory Block (RPMB) partition.

16. The apparatus of claim 1, wherein the NVM device comprises a Trusted Computing Group (TCG) device.

17. A method comprising:
storing data in a Non-Volatile Memory (NVM) device; and
locking or unlocking, at partition logic circuitry, a partition on the NVM device in response to a command,
wherein the NVM device is physically migratable to a different platform and the NVM device is protected after power loss during runtime, wherein the partition logic circuitry locks or unlocks the partition in response to the command and a cryptographic key.

18. The method of claim 17, further comprising integrity protecting the NVM device.

19. The method of claim 17, further comprising allowing authorized software to modify the partition.

20. The method of claim 17, further comprising blocking unauthorized software from modifying the partition.

21. The method of claim 17, further comprising programming the cryptographic key into the NVM device.

22. The method of claim 17, further comprising causing each blob, to be written to the NVM device, to include a Hash-based Message Authentication Code (HMAC), wherein the HMAC is determined based at least in part on the cryptographic key.

23. One or more non-transitory computer-readable media comprising one or more instructions that when executed on a processor configure the processor to perform one or more operations to:
store data in a Non-Volatile Memory (NVM) device; and
lock or unlock, at partition logic circuitry, a partition on the NVM device in response to a command,
wherein the NVM device is physically migratable to a different platform and the NVM device is to be protected after power loss during runtime, wherein the partition logic circuitry is to lock or unlock the partition in response to the command and a cryptographic key.

24. The one or more computer-readable media of claim 23, further comprising one or more instructions that when executed on the at least one processor configure the at least one processor to perform one or more operations to cause integrity protection of the NVM device.

25. The one or more computer-readable media of claim 23, further comprising one or more instructions that when executed on the at least one processor configure the at least one processor to perform one or more operations to cause blocking of unauthorized software from modifying the partition.
